(19) United States
(12) Patent Application Publication
(10) Pub. No.: US 2024/0412133 A1
(43) Pub. Date: Dec. 12, 2024

(54) RESOURCE USAGE AMOUNT MANAGEMENT SYSTEM AND RESOURCE USAGE AMOUNT MANAGEMENT METHOD

(71) Applicant: Hitachi, Ltd., Tokyo (JP)

(72) Inventors: Taichi SHIKAWA, Tokyo (JP); Motonari HAMANAKA, Tokyo (JP); Hiroaki NAKAI, Tokyo (JP)

(21) Appl. No.: 18/642,868

(22) Filed: Apr. 23, 2024

(30) Foreign Application Priority Data
Jun. 9, 2023 (JP) 2023-095798

(51) Int. Cl. G06Q 10/0631; G06Q 10/0637; G06Q 10/0835

(52) U.S. Cl. CPC G06Q 10/06315; G06Q 10/06375; G06Q 10/0835

(57) ABSTRACT

A resource usage amount management system stores process management data representing a flow of a plurality of tasks related to production or provision of an item. For each of the tasks, the process management data includes: task information that includes information related to the task with respect to each item related to the task; element information that includes information related to each of a plurality of elements associated with the task, and is associated with the task information on the task; and environment information that includes information related to the resource usage amount for each of the plurality of elements, and is associated with the element information on the element. The resource usage amount management system calculates the resource usage amount in an item-by-item basis, according to information represented by the process management data, and association of information.

### CROSS-REFERENCE TO RELATED APPLICATION

The present application claims priority from Japanese application JP2023-095798, filed on Jun. 9, 2023, the content of which is hereby incorporated by reference into this application.

### BACKGROUND

The present invention generally relates to a technique for managing a resource usage amount.

An example of a resource usage amount includes an energy usage amount. As a technique related to energy usage amount management, for example, a technique disclosed in Patent Literature 1 has been known. As for information management, for example, techniques disclosed in Patent Literatures 2 and 3 have been known.

### PATENT LITERATURE

[Patent Literature 1] Japanese Patent Laid-Open No. 2020-149133
[Patent Literature 2] Japanese Patent Laid-Open No. 2019-153051
[Patent Literature 3] US2019/0271969

### SUMMARY

In places, such as factories and offices, energy (e.g., electric power) or other resources are used by tasks. The usage amount of resources affects the CO₂ emission or the like. Accordingly, it is desirable for a user to appropriately manage the resource usage amount related to production or provision of items.

A resource usage amount management system stores process management data representing a flow of a plurality of tasks related to production or provision of an item. For each of the plurality of tasks, the process management data includes: task information that includes information related to the task with respect to each item related to the task; element information that includes information related to each of a plurality of elements associated with the task, and is associated with the task information on the task; and environment information that includes information related to the resource usage amount for each of the plurality of elements, and is associated with the element information on the element. The resource usage amount management system calculates the resource usage amount in an item-by-item basis, according to information represented by the process management data, and association of information, and provides usage amount information that is information based on the aggregated resource usage amount.

According to the present invention, the user can appropriately manage the resource usage amount related to production or provision of items.

### BRIEF DESCRIPTION OF THE DRAWINGS

FIG. 1 shows a configuration example of an entire system that includes a resource usage amount management system according to a first embodiment;

FIG. 2 shows an example of a logic configuration of the resource usage amount management system;

FIG. 3 shows an example of a structure of part of a process management model according to the first embodiment;

FIG. 4 shows an example of aggregation of the resource usage amount;

FIG. 5A shows an example of a displayed view based on an aggregate result of the resource usage amount;

FIG. 5B shows an example of a displayed view based on aggregate results of the resource usage amount;

FIG. 6 schematically shows an example of linking of supplier process models of a plurality of suppliers;

FIG. 7 shows an example of a screen presented to the supplier;

FIG. 8A shows an example of recombination of tasks;

FIG. 8B shows line consolidation;

FIG. 9 shows an example of mixed flow production;

FIG. 10 shows an example of a structure of part of a process management model according to a second embodiment;

FIG. 11 schematically shows an example of processes using the process management model according to the second embodiment; and

FIG. 12 shows an example of an operating time period of a facility.

### DESCRIPTION OF EMBODIMENTS

In the following description, “interface” may be one or more interface devices. The one or more interface devices may be at least one of the followings.
I/O interfaces that are one or more I/O (Input/Output) interface devices. The I/O (Input/Output) interface device is an interface device for at least one of an I/O device and a remote display computer. The I/O interface device for the display computer may be a communication interface device. At least one I/O device may be a user interface device, for example, any of input devices, such as a keyboard and a pointing device, and of an output device, such as a display device.
Communication interfaces that are one or more communication interface devices. The one or more communication interface devices may be one or more communication interface devices of the same type (e.g., one or more NICs (Network Interface Cards)), or two or more different types of communication interface devices (e.g., an NIC and an HBA (Host Bus Adapter)).

In the following description, “memory” is one or more memory devices that are an example of one or more storage devices, and may typically be a main storage device. At least one memory device in the memory may be a volatile memory device or a non-volatile memory device.

In the following description, “persistent storage” is one or more persistent memory devices that are an example of one or more storage devices. The persistent storage device may typically be a non-volatile storage device (e.g., an auxiliary storage device), and specifically, for example, a HDD (Hard Disk Drive), a SSD (Solid State Drive), a NVME (Non-Volatile Memory Express) drive, or a SCM (Storage Class Memory).

In the following description, “storage” may be at least a memory between a memory and a persistent storage.

In the following description, “processor” is one or more processor devices. At least one processor device may typically be a microprocessor device, such as a CPU (Central Processing Unit), or may be another type of a processor device, such as a GPU (Graphics Processing Unit). At least one processor device may be a single core or multicore one. At least one processor device may be a processor core. At least one processor device may be a processor device in a broad sense, such as a circuit that is a collective entity of gate arrays, through a hardware description language, performing part of or the entire processing (e.g., a FPGA (Field-Programmable Gate Array), a CPLD (Complex Programmable Logic Device), or an ASIC (Application Specific Integrated Circuit)).

In the following description, a function is sometimes described by representation of “yyy unit”. The function may be achieved by one or more computer programs being executed by a processor, achieved by one or more hardware circuits (e.g., FPGAs or ASICs), or achieved by a combination of them. In the case where the function is achieved by the program being executed by the processor, a predetermined process is executed appropriately using a storage and/or an interface, etc. Accordingly, the function may be regarded as at least part of the processor. A process described with a function as a subject may be a process executed by a processor or an apparatus that includes the processor. The program may be installed from a program source. The program source may be, for example, a program distribution computer, or a computer-readable storage medium (e.g., a non-transitory storage medium). The description of each function is only one example. A plurality of functions may be integrated into one function, or one function may be divided into a plurality of functions.

In the following description, in a case where the same type of elements is not discriminated and described, a common symbol of reference symbols is sometimes used. In a case where the same type of elements is discriminated, the reference symbols are sometimes used.

In the following description, “4M” means the first letters of four elements that are Man, Machine, Method, and Material. In the following description, the four elements constituting “4M” are represented as “Man”, “Machine”, “Method”, and “Material”, which are collectively called “4M elements”.

### First Embodiment

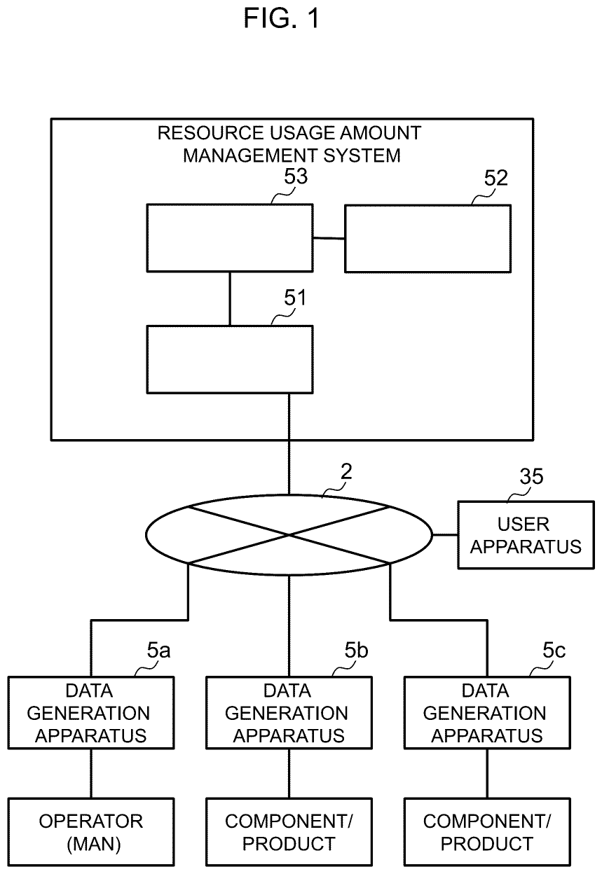

FIG. 1 shows a configuration example of an entire system that includes a resource usage amount management system according to a first embodiment.

In the present embodiment, the resource usage amount management system 1 is a physical computer system (one or more physical computers), and includes an interface 51, a storage 52, and a processor 53 coupled to them. The resource usage amount management system 1 may be a logical computer system (e.g., a virtual machine, or a cloud computing system) based on a physical computer system.

The interface 51 is coupled to a network 2 (e.g., the Internet, or a WAN (Wide Area Network)). One or more data generation apparatuses 5 (e.g., data generation apparatuses 5a to 5c) and a user apparatus 35 are coupled to the network 2. The data generation apparatuses 5 and the user apparatus 35 are coupled to the resource usage amount management system 1 via the network 2.

Each data generation apparatus 5 is an apparatus that collects or generates actual data. For example, the data generation apparatus 5a may be a barcode reader that obtains a task log of an operator (man), or a PC or a server that collects a task log. The data generation apparatus 5b may be a machine that processes components, or assembles a finished product. The data generation apparatus 5c may be a sensor that collects an inspection information on an RFID (Radio Frequency IDentifier) assigned to a component or a finished product. Actual data collected or generated by the data generation apparatuses 5 may be transmitted to the resource usage amount management system 1 (and/or a storage that is coupled to the network 2 and resides outside of the resource usage amount management system 1) via the network 2. The “actual data” may be data generated or collected at a site (e.g., a production site), and in particular, data related to an entity belonging to any of the 4M elements, for example, at least part of data related to a facility belonging to Machine, data related to an operator belonging to Man, data related to a component or a product belonging to Material, and data related to a procedure belonging to Method. Hereinafter, the entity belonging to the 4M element is sometimes called “4M entity”.

The user apparatus 35 is an information processing apparatus (computer), such as a personal computer or a smartphone. The resource usage amount management system 1 may be a server, and the user apparatus 35 may be a client.

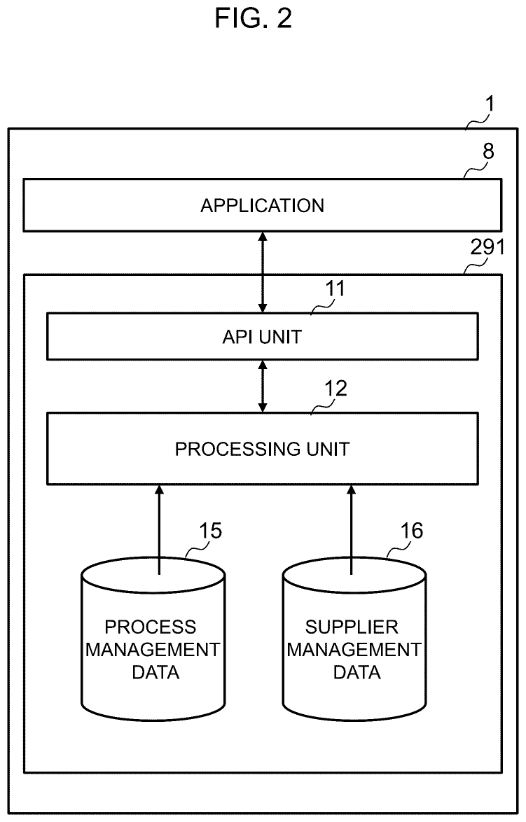

FIG. 2 shows an example of the logic configuration of the resource usage amount management system 1.

The storage 52 of the resource usage amount management system 1 stores, for example, process management data 15, and supplier management data 16. The process management data 15 represents an after-mentioned process management model. The supplier management data 16 includes information related to one or more suppliers.

The resource usage amount management system 1 includes middleware 291 and an application 8. The processor 53 executes these pieces of software. The application 8 may reside outside of the resource usage amount management system 1.

The middleware 291 includes an API (Application Programming Interface) unit 11, and a processing unit 12. The middleware 291 may communicate with the user apparatus 35 via or not via the application 8. In the latter case, the middleware 291 may include a UI (User Interface) unit, not shown, and the UI unit may communicate with the user apparatus 35.

The API unit 11 communicates with the application 8. For example, the API unit 11 accepts a first request by the application 8, and transmits, to the processing unit 12, a second request (e.g., a search request) based on the first request. The API unit 11 receives a response to the second request from the processing unit 12, and returns, based on this response, a response to the first request issued by the application 8, to the application 8.

The processing unit 12 accepts the request (e.g., the second request) via the API unit 11 (or the UI unit), and refers to or updates the process management data 15, based on this request (for example, refers to the supplier management data 16 as required), and returns a response based on a result, to the request source.

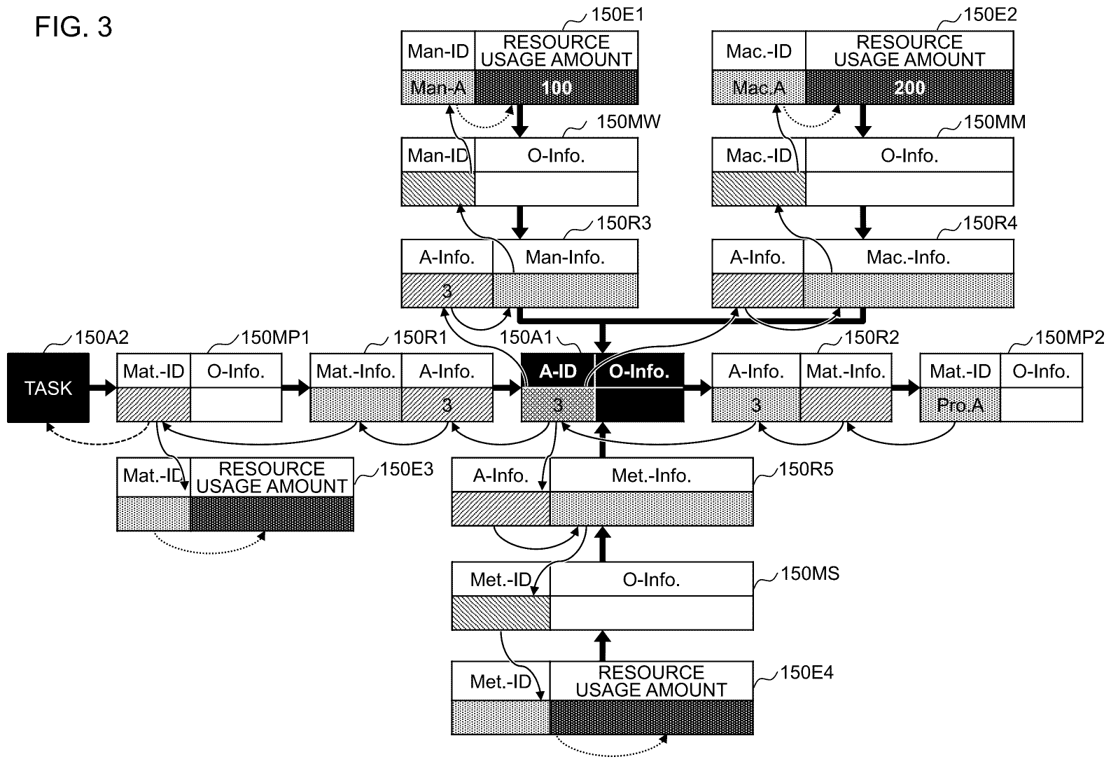

FIG. 3 shows an example of part of a data structure of the process management model represented by the process management data 15.

The process management model represents the order (flow) of a plurality of tasks, and information related to an entity belonging to each of one or more 4M elements associated with each task, and also represents the resource usage amount related to each entity belonging to the 4M element, with respect to this entity.

Specifically, for example, the process management model is a graph that includes nodes 150 and edges. The edges in the graph may include undirected edges, but may typically directed edges. The process management model may be a DAG (Directed Acyclic Graph).

The nodes 150 include information related to the task, relationship information that is related to the 4M entity, and is for associating information related to the 4M entity with the information related to the task, or information related to the environment of the site. Hereinafter, the node 150 including information related to the task is sometimes called “task node 150A”, the node 150 including information related to the 4M entity is sometimes called “4M node 150M”, the node 150 including the relationship information is sometimes called “relationship node 150R”, and the node 150 including information related to the environment of the site is sometimes called “environment node 150E”.

The information that the task node 150A has includes an A-ID (an ID of the task corresponding to the task node 150A), and an O-Info. (information related to the operation of the task corresponding to the task node 150A). The O-Info. may include, for example, information representing when and what operation was performed (e.g., information that includes information representing the start time and the operating time of the process for the product with respect to each product), and information representing which supplier the task belongs to.

The information that the 4M node 150M has includes an ID of the 4M entity corresponding to the 4M node 150M, and O-Info. that is information related to operation of the 4M entity corresponding to the 4M node 150M. The O-Info. may include, for example, information representing when and what operation was performed (e.g., information that includes information representing the operation start time and the operation end time on an operation-by-operation basis or a product-by-product basis), and information representing which supplier the 4M entity belongs to. According to the example shown in FIG. 3, the 4M nodes 150M include a Man node 150MW, a Machine node 150MM, a Material node 150MP, and a Method node 150MS. According to the example shown in FIG. 3, the IDs of the 4M entities include a Man-ID (an ID of an operator), a Mac.-ID (an ID of a facility), a Mat.-ID (an ID of a component or a product), and a Met.-ID (an ID of a procedure). With respect to each 4M element, one 4M node 150M may be associated with one task node 150A for this 4M element, and may include an entity ID for each 4M element (e.g., each of an operator A, an operator B, . . . ) belonging to this 4M element (e.g., Man), or may be present for each 4M entity belonging to this 4M element.

The information that the relationship node 150R has includes at least part (e.g., at least A-ID) of information related to the task, and at least part (e.g., at least the 4M entity ID) of information related to the 4M entity associated with the information related to the task. Note that the 4M node 150M may be associated with the task node 150A by one edge not via the relationship node 150R, and the information that the relationship node 150R has may be associated with the edge. The 4M node 150M of at least one 4M entity can be associated with one task node 150A by at least one relationship node 150R.

The process management model includes the environment node 150E as described above, in addition to these nodes 150A, 150M, and 150R. According to the example shown in FIG. 3, the environment node 150E is the node 150 associated with the 4M node 150M. Specifically, for example, with respect to the 4M entity corresponding to the 4M node 150M associated with the environment node 150E, the environment node 150E includes the ID of the 4M entity, and information representing the resource usage amount (the resource usage amount used by the 4M entity) of the 4M entity. For each 4M entity, the value of the resource usage amount represented by the information that the environment node 150E has may be a value determined by the processing unit 12 according to a predetermined method (e.g., a value determined by the processing unit 12 based on statistics of values previously measured as results of the process), and a value input by a user through the user apparatus 35.

A part obtained by excluding the environment node 150E and edges linked to the environment node 150E from the process management data 15 (data representing the process management model) may be constructed by the method disclosed in Patent Literature 2 or 3. The environment node 150E corresponds to a leaf node. Instead of or in addition to this, an environment node 150E as an intermediate node may be prepared. Information that the environment node 150E has may be included in the 4M node 150M.

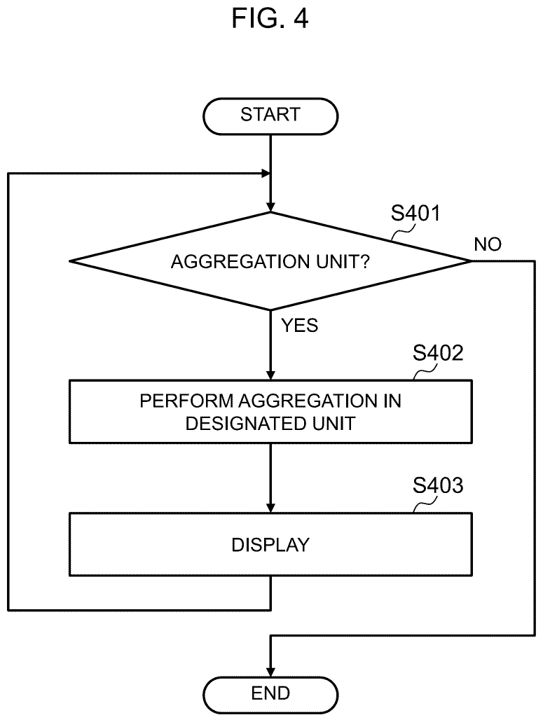

In the example shown in FIG. 3, direct or bent curve and thick arrows are edges. In the example shown in FIG. 3, solid curves or broken arrows represent examples of information tracing directions. For example, one task node 150A1 is associated with 4M nodes 150MP1, 150MP2, 150MW, 150MM, and 150MS through relationship nodes 150R1 to 150R5. The 4M node 150MP1 is associated with an environment node 150E3. The 4M node MW is associated with an environment node 150E1. The 4M node 150MM is associated with an environment node 150E2. The 4M node 150MS is associated with an environment node 150E4. The processing unit 12 identifies the relationship node 150R1 to 150R5 with the key of the A-ID of the task node 150A1, and identifies the 4M nodes 150MP1, 150MP2, 150MW, 150MM, and 150MS with the keys that are the IDs of information on the relationship nodes 150R1 to 150R5. The processing unit 12 identifies the environment nodes 150E1 to 150E4 with the keys of the 4M element IDs of the identified 4M nodes 150MP1, 150MP2, 150MW, 150MM, and 150MS, and identifies the resource usage amounts of the respective 4M entities from the environment nodes 150E1 to 150E4. The processing unit 12 performs such a process for each task node 150A to thereby identify the resource usage amount of each 4M entity with respect to each task node 150A, and aggregates the resource usage amount in a freely selected unit or in a unit designated by the user. The processing unit 12 displays the resource usage amount aggregated in this unit, on the user apparatus 35. The unit may be, for example, any of a task unit, 4M element unit, 4M entity unit (e.g., a product unit), and a supplier unit (which is a unit where one or more tasks are integrated (e.g., units of “production”, “distribution”, and “use”), and may be called “supply chain process unit” or “partner unit”). For example, in a case of aggregating the resource usage amount of a certain product, the processing unit 12 may calculate, as the resource usage amount of this product, the sum of the resource usage amounts of finished products and components that are categorized as this product and represented by the 4M node 150MP. The processing unit 12 may add, to the sum, the entire or part of the resource usage amounts represented by the nodes of the 4M elements engaging with this product, and calculate the result as the resource usage amount of this product. The unit with which the resource usage amount is aggregated, and the method of aggregating the resource usage amount may be predetermined, and appropriately changed by the user. For example, as exemplified in FIG. 4, if designation of the aggregation unit is received through the API unit 11 (or the UI unit) (S401: YES), the processing unit 12 aggregates the resource usage amount in the designated aggregation unit (S402), and displays the resource usage amount aggregated in a unit-by-unit basis on the user apparatus 35 through the API unit 11 (or the UI unit) (S403). According to the present embodiment, the resource usage amount of each product can be calculated based on the resource usage amount with respect to each 4M element.

The user apparatus 35 may issue a request for the resource usage amount to the application 8, and the API unit 11 of the middleware 291 may receive the request for the resource usage amount, from the application 8 having received this request. In response to the request received by the API unit 11, the processing unit 12 may refer to the process management data 15, and trace the nodes in the process management model represented by the process management data 15, in the designated unit, or in accordance with the designated target (e.g., the task, 4M element, or 4M entity), thus aggregating the resource usage amount in the designated unit or in accordance with the target. The processing unit 12 may return data representing the aggregated resource usage amount to the application 8 through the API unit 11. The application 8 may transmit the data representing the resource usage amount to the user apparatus 35, based on the data received through the API unit 11.

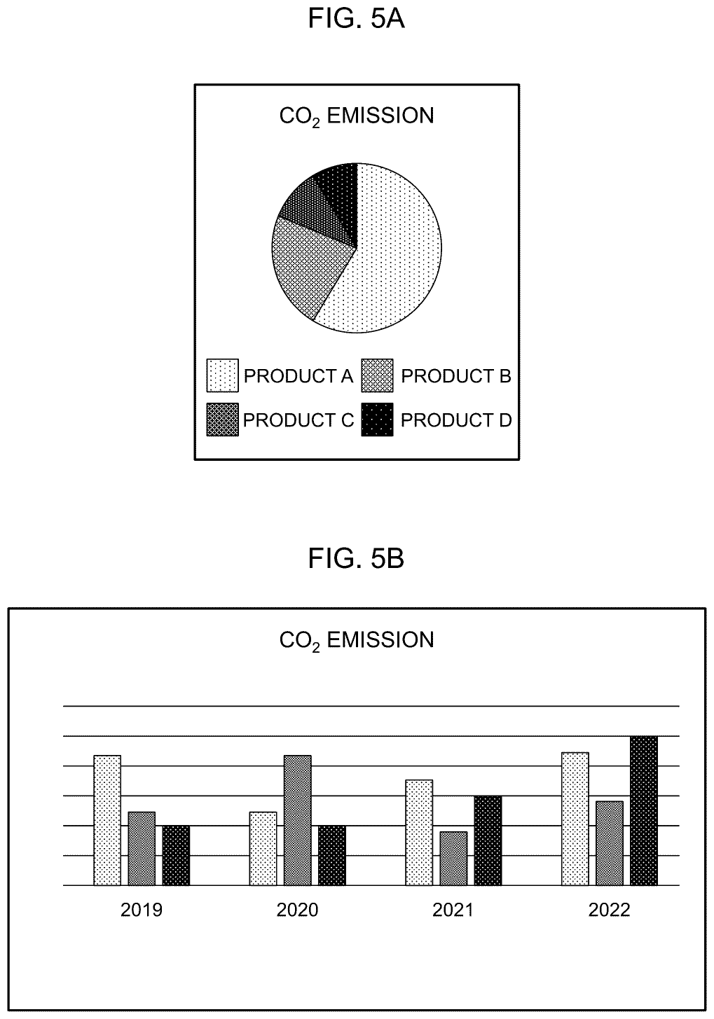

The representation of the resource usage amount may be the usage amount of the resource (e.g., energy, such as electric power) itself, or a quantity (e.g., the usage amount or emission) obtained by a predetermined conversion method using the usage amount of the resource itself. Specifically, for example, the representation of the resource usage amount may be the CO₂ emission calculated based on the aggregated usage amount of the resource itself. Accordingly, for example, on the user apparatus 35, the CO₂ emission of each product can be displayed as shown in FIG. 5A, and the time series of CO₂ emission in the unit of existing 4M category (e.g., any of units of Man, Machine, and Method), or in a supplier unit (e.g., units such as of “production”, “distribution”, and “use”) as shown in FIG. 5B. To obtain the time series of resource usage amount (CO₂ emission), for example, information that each environment node 150E has may include information representing the resource usage amount in a unit time period (e.g., per day or per hour).

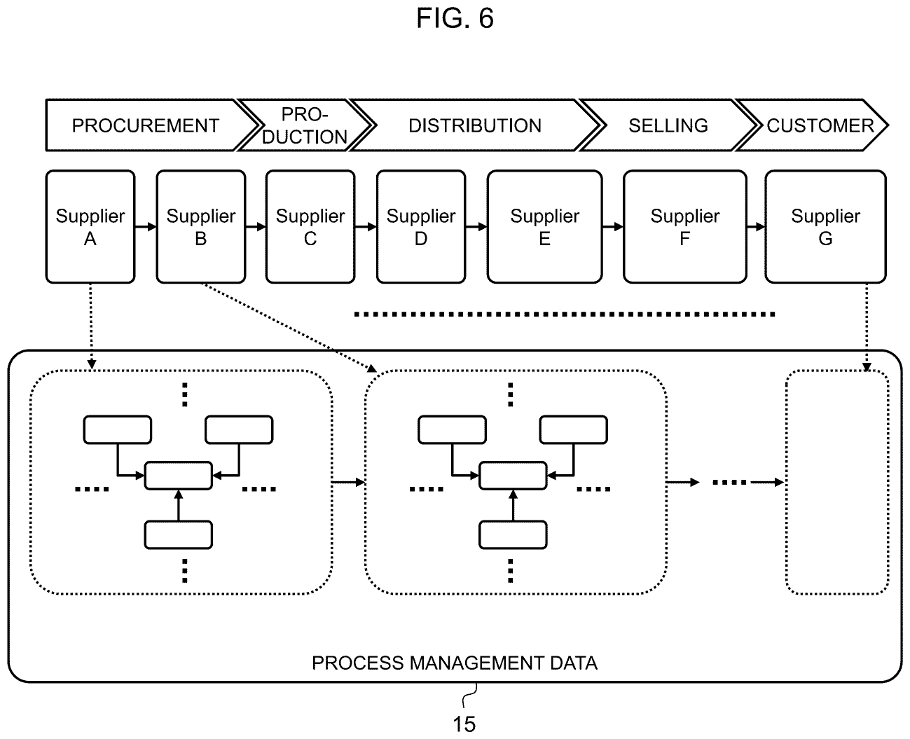

According to the present embodiment, for example, as shown in FIG. 6, there are different suppliers A to G related to a supply chain that includes procurement, production, distribution, selling, and customers. The relationship among the suppliers A to G may be a serial relationship as shown in the diagram, or a relationship of DAG (Directed Acyclic Graph) where the suppliers are adopted respectively as nodes. In FIG. 6, elements related to the supply chain may be elements or names different from “suppliers”.

The supplier management data 16 may include supplier process data that is data representing the supplier process models (models of processes of the suppliers), on a supplier-by-supplier basis. The supplier process model may be a model that includes the task nodes, relationship nodes, and 4M nodes (e.g., DAG). The 4M node in the supplier process model may be associated, for example, by the processing unit 12, with the relationship node that has information representing the resource usage amount of the 4M entity corresponding to the 4M node. For example, the supplier management data 16 may include information representing the order of tasks performed by the supplier on a supplier-by-supplier basis, and information representing the 4M entities related to the tasks on a task-by-task basis. Furthermore, with respect to each supplier, the supplier management data 16 may include information representing a task link that is a link between a task of the supplier and a task of another supplier. The processing unit 12 may identify the task link between the suppliers from the supplier management data 16, and associate the task node in the supplier process model of the supplier, and the task node in the supplier process model of the other supplier on a supplier-by-supplier basis, according to the identified task link. According to this association, the task nodes in the different supplier process models may be coupled by a plurality of edges via the relationship nodes and the 4M nodes of the component and product. The supplier process models of the different suppliers A to G in the supply chain are linked by the processing unit 12, based on the supplier management data 16, as described above, thus allowing preparation of the process management data 15 representing the process management model where the supplier process models of the suppliers A to G are linked. Based on the resource usage amount represented by each environment node in the process management model (the model ranging over the suppliers A to G) represented by the process management data 15, the processing unit 12 can calculate the resource usage amount (CO₂ emission) of each product made and sold through the different suppliers A to G. For example, the processing unit 12 provides a finished product maker (supplier) with information representing the resource usage amount in unit of each product provided by the finished product maker, based on each environment node related to each supplier (e.g., a component maker) upstream of the finished product maker, thus being able to demonstrate how each product provided by the finished product maker is successfully contributing to the environment.

The user apparatus 35 may reside in each supplier. In response to a request by the supplier, the processing unit 12 may determine what information is presented to the supplier, based on the process management data 15, and/or how information related to the resource usage amount aggregated based on the process management data 15 is presented to the supplier, based on, for example, the supplier management data 16.

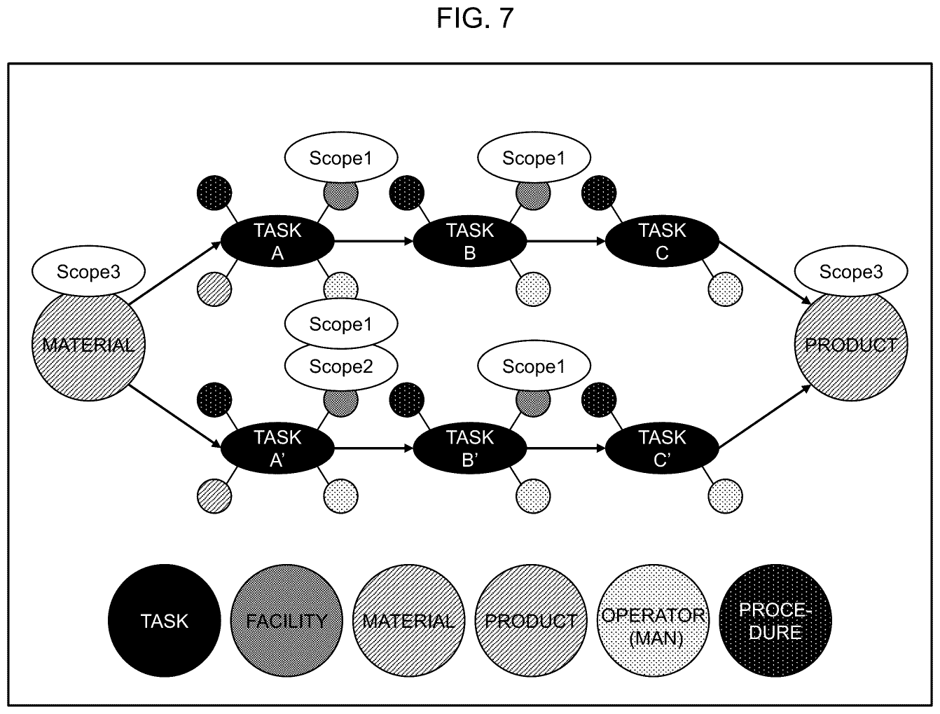

FIG. 7 shows an example of a screen displayed on the user apparatus 35 of the supplier by the processing unit 12 through the API unit 11 (or the UI unit).

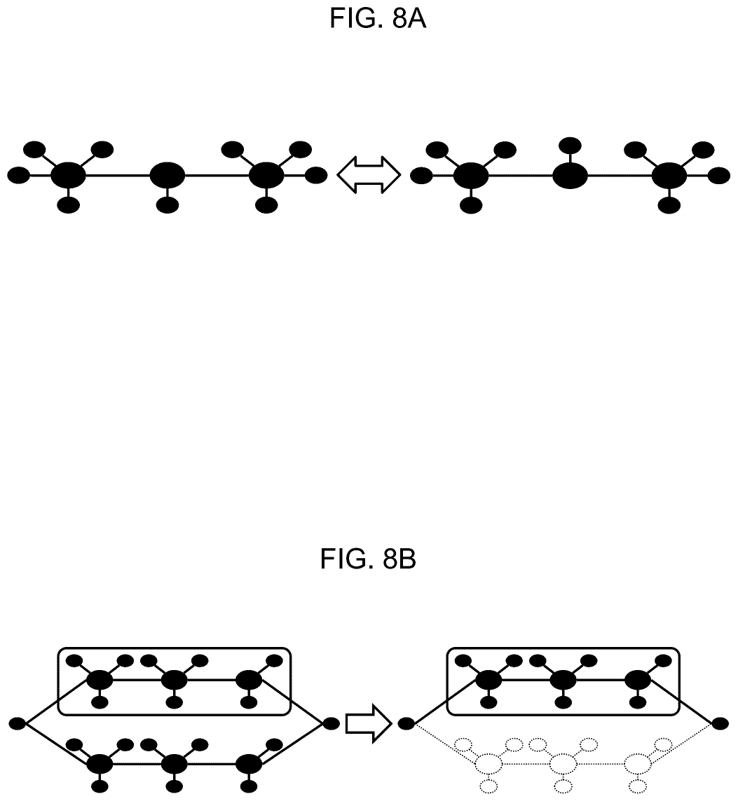

In this example, the representation of the resource usage amount is the CO₂ emission. For example, the supplier management data 16 or the processing unit 12 includes a Scope rule definition that includes definitions of Scopes 1 to 3. The CO₂ emission directly from the own company (and 4M elements related to the CO₂ emission) in the CO₂ emission of the own company belongs to Scope 1. The CO₂ emission based on electric power purchased from the outside of the company (and 4M elements related to the CO₂ emission) in the CO₂ emission of the own company belongs to Scope 2. The CO₂ emission of the suppliers other than the own company (and 4M elements related to the CO₂ emission) belongs to Scope 3. In a request by the supplier, it may be designated which supplier is the own company. The processing unit 12 may identify the supplier that is the own company, and determine which node in the process management model represented by the process management data 15 belongs to which Scope, based on the Scope rule definition. As exemplified in FIG. 7, the processing unit 12 may provide the request source with the model based on the process management model, and a screen that displays the relationship between the nodes and Scopes in the model. Although not shown, the processing unit 12 may aggregate the CO₂ emission (and the breakdown) for the Scope concerned with respect to each of Scopes 1 to 3 on a Scope-by-Scope basis, and provide information representing the aggregation to the request source. The resource usage amount (CO₂ emission) for each task is organized with respect to each of Scopes 1 to 3 as described above, and aggregation of the resource usage amount (CO₂ emission) in a freely selected unit, such as the task, product, or lot (product lot) can thus be achieved. For example, as shown in the example shown in FIG. 8A, the supplier can check the CO₂ emission including upstream and downstream of the own company, based on the presented information, and grasp or discuss task recombination, and effects of task improvement. As shown in the example shown in FIG. 8B, the supplier can perform discussion about consolidation of production lines on a line having a high resource usage amount efficiency, based on the relationship between the resource usage amount (CO₂ emission) and the amount of production of the products, or the like.

Scopes 1 to 3 are an example of categories of the resource usage amount (CO₂ emission) and 4M elements. According to another example of the category, the own company, upstream, or downstream may be adopted, or yet another category may be adopted.

### Second Embodiment

A second embodiment is described. Here, the difference from the first embodiment is mainly described, and description of the points common to those of the first embodiment is omitted or simplified.

According to the first embodiment, in a case where one item type of products is produced on one production line, the resource usage amount (CO₂ emission) per product can be calculated by dividing the total resource usage amount obtained about the one production line by the number of produced products.

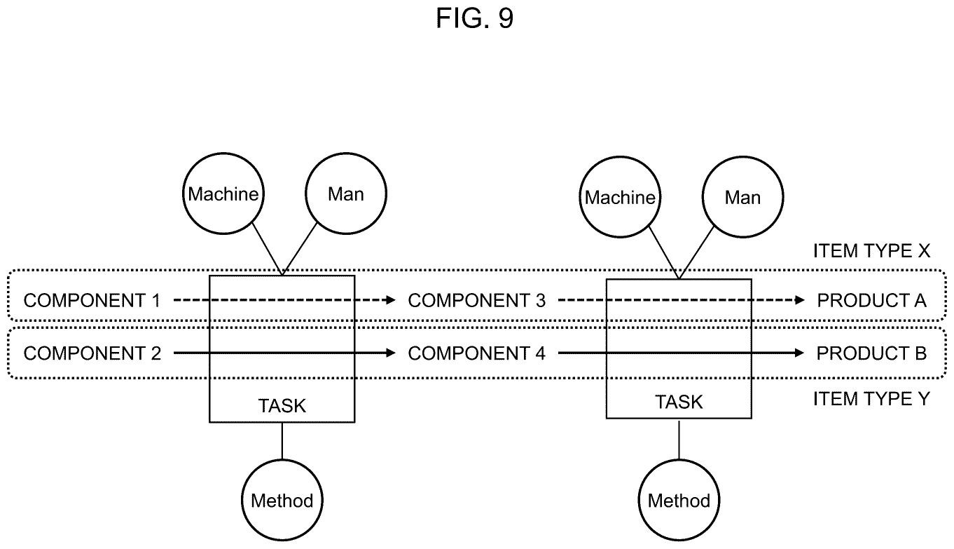

However, in a mixed flow production as exemplified in FIG. 9, such calculation is difficult. Specifically, in a case where different item types of products are processed in one task, it is difficult to identify the breakdown (e.g., the resource usage amount for each item type) of the resource usage amount associated with this task.

In the present embodiment, the resource usage amount (CO₂ emission) concerning production or provision of products produced on the same production line by mixed flow production (mixed flow production with production conditions different depending on the item type) can be calculated with respect to each item type.

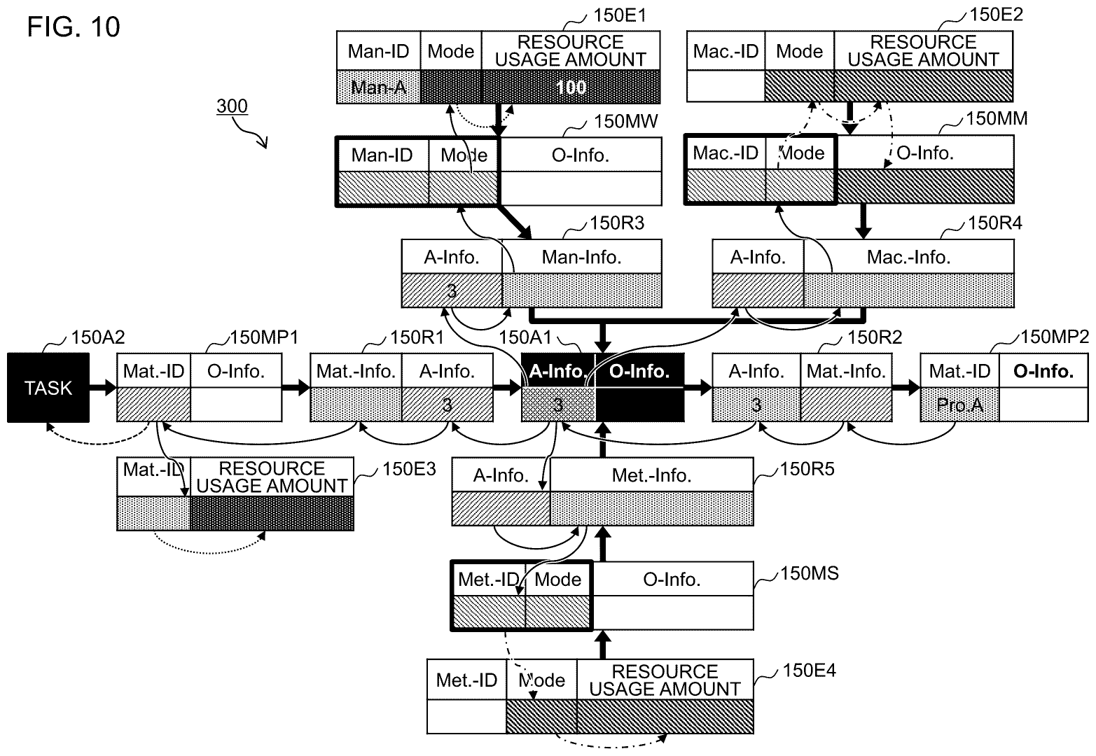

FIG. 10 shows an example of the structure of part of the process management model according to the second embodiment.

For at least some 4M elements or 4M entities, the entity mode is managed (e.g., with respect to each item type (or each product), the used entity mode is managed), and the operating time period, and the resource usage amount per unit time period are managed with respect to each entity mode. The processing unit 12 can aggregate the resource usage amount according to the entity mode used for producing products belonging to the item type concerned, with respect to each item type (or each product). That is, more correct or detailed aggregation and management of the resource usage amount can be achieved. Information representing the correspondence relationship between the item types and products are included in, for example, the supplier management data 16. The processing unit 12 may identify the item type to which the product concerned belongs with respect to each product, from the supplier management data 16.

The “entity mode” is a mode related to the 4M entity. The details of the entity mode are different depending on which 4M element the 4M entity belongs to (i.e., in the present embodiment, “mode” is used in a broad sense). For example, in a case where the 4M entity is an operator, an example of the entity mode may be the skill level. In a case where the 4M entity is a procedure, an example of the entity mode may be the procedure type. In a case where the 4M entity is a facility, an example of the entity mode may be the operation mode.

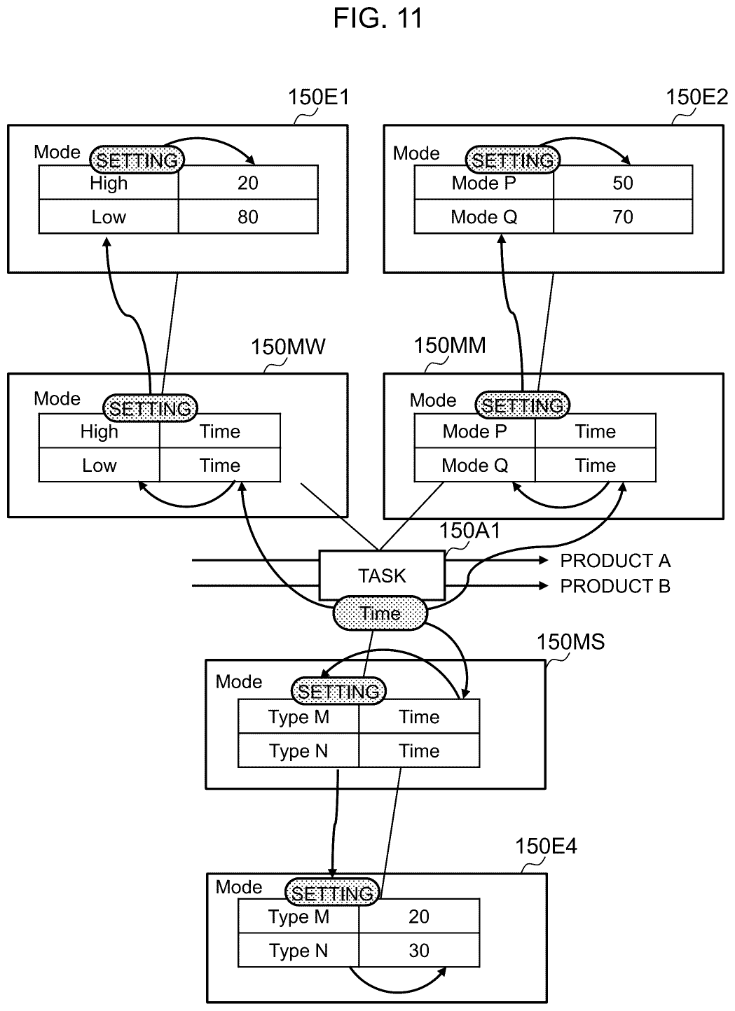

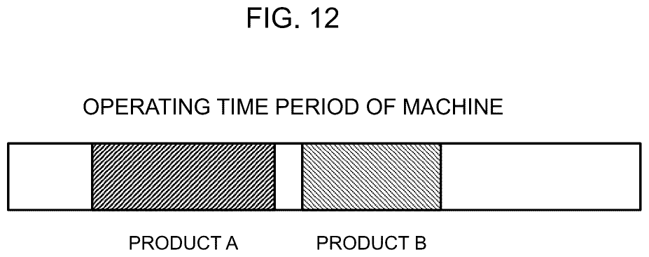

FIG. 11 schematically shows an example of processes using the process management model according to the second embodiment. Note that in FIG. 11, illustration of the relationship node 150R is omitted.

The O-Info. of the task node 150A1 includes information representing the time period related to the task corresponding to the task node 150A1, for example, information representing the operating time slot (e.g., the start time and the end time) of each product. At least some of the 4M nodes 150M have Mode (information that includes information representing a plurality of (or one) entity modes), and O-Info. (information that includes information representing one or more operating time slots with respect to each entity mode). The environment node 150E associated with the 4M node 150M including Mode has Mode (information that includes information representing a plurality of (or one) entity modes), and information representing the resource usage amount (information that includes information representing the resource usage amount per unit time period with respect to each entity mode). In the mixed flow production, setting (entity mode) related to production is different depending on each item type.

The processing unit 12 identifies a time slot (hereinafter, in this paragraph, “task time slot”) in which the task is performed about the product represented by the Material node 150MP, from the task node 150A associated with the Material node 150MP. The processing unit 12 identifies the 4M node 150M of the 4M entity related to the product, based on the task node 150A and the relationship node 150R. The processing unit 12 identifies the entity mode corresponding to the time slot that includes the task time slot, from the 4M node 150M. The processing unit 12 identifies the resource usage amount corresponding to the identified entity mode, from the environment node 150E associated with the 4M node 150M. The processing unit 12 calculates the resource usage amount of the product, from the identified resource usage amount (resource usage amount per unit time period) and the task time slot. The processing unit 12 can identify the correspondence relationship between the product and the item type, from the supplier management data 16, and calculate the resource usage amount of each item type from the resource usage amount of each product. More specifically, for example, this is as follows.

For example, the Mode of the Man node 150MW represents a plurality of skill levels (e.g., “High” and “Low”), and the O-Info. of the Man node 150MW represents the time slot with respect to each skill level. Likewise, the Mode of the environment node 150E1 represents the plurality of skill levels. The information representing the resource usage amount includes information representing the resource usage amount per unit time period with respect to each skill level. The processing unit 12 identifies, for example, the task time slot for a product A, from the O-Info. of the task node 150A, and identifies the skill level (e.g., “High”) corresponding to a time slot including the time slot, from the Man node 150MW. The processing unit 12 identifies the resource usage amount (e.g., “20”) per unit time period corresponding to the identified skill level (e.g., “High”), from the environment node 150E1, and calculates the resource usage amount for the product A, with respect to the Man and the task, from the identified resource usage amount per unit time period and the task time slot for the product A.

For example, the Mode of the Machine node 150MM represents a plurality of operation modes (e.g., “Mode P” and “Mode Q”), and the O-Info. of the Machine node 150MM represents the time slot with respect to each operation mode. Likewise, the Mode of the environment node 150E2 represents the plurality of operation modes. The information representing the resource usage amount includes information representing the resource usage amount per unit time period with respect to each operation mode. The processing unit 12 identifies, for example, the task time slot for a product A, from the O-Info. of the task node 150A, and identifies the operation mode (e.g., “Mode Q”) corresponding to a time slot including the time slot, from the Machine node 150MM. The processing unit 12 identifies the resource usage amount (e.g., “50”) per unit time period corresponding to the identified operation mode (e.g., “Mode Q”), from the environment node 150E2, and calculates the resource usage amount for the product A, with respect to the Machine and the task, from the identified resource usage amount per unit time period and the task time slot for the product A.

For example, the Mode of the Method node 150MS represents a plurality of procedure types (e.g., “Type M” and “Type N”), and the O-Info. of the Method node 150MS represents the time slot with respect to each procedure type. Likewise, the Mode of the environment node 150E4 represents the plurality of procedure types. The information representing the resource usage amount includes information representing the resource usage amount per unit time period with respect to each procedure type. The processing unit 12 identifies, for example, the task time slot for the product A, from the O-Info. of the task node 150A, and identifies the procedure type (e.g., “Type M”) corresponding to a time slot including the time slot, from the Method node 150MS. The processing unit 12 identifies the resource usage amount (e.g., “20”) per unit time period corresponding to the identified procedure type (e.g., “Type M”), from the environment node 150E4, and calculates the resource usage amount for the product A, with respect to the Method and the task, from the identified resource usage amount per unit time period and the task time slot for the product A.

Although some embodiments have thus been described above, these are examples for describing the present invention, and does not intend to limit the scope of the invention to these embodiments. The present invention can be executed in other various modes. For example, freely selected two or more embodiments among the embodiments described above can be combined.

Note that the aforementioned description can be summarized as follows, for example. The following summarized description may include supplementary description to the aforementioned description, and description of modifications. Note that in the following description, “item” may be any of a component, a partially finished product, and a finished product.

The resource usage amount management system 1 includes: the storage 52 that stores the process management data 15 representing the flow of tasks related to production or provision of items; and the processor 53 coupled to the storage 52. For each of the tasks, the process management data 15 includes: task information that includes information related to the task with respect to each item related to the task; element information that includes information related to each of a plurality of elements associated with the task, and is associated with the task information on the task; and environment information that includes information related to a resource usage amount of each of the plurality of elements, and is associated with the element information on the element. The processor 53 calculates the resource usage amount in an item-by-item basis, according to information represented by the process management data 15, and association of information, and provides usage amount information that is information based on the aggregated resource usage amount. Accordingly, the user can appropriately manage the resource usage amount related to production or provision of items.

The plurality of elements may be 4M elements that are Man, Machine, Method, and Material. Accordingly, the resource usage amount for each 4M element (e.g., the resource usage amount for each 4M element on a task-by-task basis) is calculated, and the usage amount information representing the calculated resource usage amount can be provided for the user.

For the tasks related to items of different item types among the plurality of tasks, with respect to at least one 4M element associated with the task concerned among Man, Machine, and Method, a plurality of element modes that are different depending on the item type may be provided. With respect to each of the element modes, the environment information associated with the element information on the 4M element may include information representing the resource usage amount corresponding to the element mode. The processor 53 may calculate the resource usage amount with respect to each item type, based on the process management data 15. The element mode may be a mode (setting) in accordance with the production condition and distribution condition. Even in a case of the production scheme of the mixed flow production or the like, and even in a case where the distribution condition is different depending on each item type on the same distribution route, the resource usage amount concerning production or provision of items can be calculated.

With respect to the task related to items of different item types, the task information may include information representing the operating time slot on an item-by-item basis. With respect to each of the element modes, the element information may include information representing the time slot corresponding to the element mode. With respect to each of the element modes, the environment information may include information representing the resource usage amount per unit time period. The processor 53 may identify the task time slot that is the time slot for the task about the item, from the task information, identify the element mode corresponding to the time slot including the identified task time slot, from the element information associated with the task information, identify the resource usage amount per unit time period corresponding to the identified element mode, from the environment information associated with the element information, and calculate the product of the identified resource usage amount per unit time period and the identified task time slot, as the resource usage amount about the task for the item. Even in the case of the production scheme of the mixed flow production or the like, and even in the case where the distribution condition is different depending on each item type on the same distribution route, the resource usage amount concerning production or provision of items can be calculated. Note that with respect to the task related to the items of different item types, the example of the element mode may be as follows.
If the element associated with the task is Machine, the plurality of element modes may be a plurality of operation modes. For example, as the facility, an air-conditioning facility may be adopted, and the resource usage amount (e.g., CO₂ emission) over the entire factory may be calculated.
If the element associated with the task is Method, the plurality of element modes may be a plurality of procedure types.
If the element associated with the task is Man, the plurality of element modes may be a plurality of skill levels.

With respect to each of the tasks, the element information on the element associated with the task may include information representing the time slot corresponding to each item. The environment information may include information representing the resource usage amount per unit time period. The processor 53 may identify the time slot corresponding to the item, from the element information associated with the task, identify the resource usage amount per unit time period, from the environment information associated with the element information, and calculate the product of the identified resource usage amount per unit time period and the identified task time slot, as the resource usage amount about the task for the item. Even in the case of the production scheme of the mixed flow production or the like, and even in the case where the distribution condition is different depending on each item type on the same distribution route, the resource usage amount concerning production or provision of items can be calculated by a method other than the method of associating the element mode with the element information or the environment information.

The resource usage amount represented by the usage amount information may be the resource usage amount as a result of aggregation in a predetermined unit or in a unit designated by a user. Accordingly, the user can appropriately manage the resource usage amount related to production or provision of items. Note that for example, the indication of the usage amount information may be such that any of the following (A) to (E), or the indication among two or more indications among the following (A) to (E) can be switched by the processor 53 in response to a request by the user. The latter may be, for example, a drill-down view from a first unit (e.g., the task unit) to a smaller second unit (e.g., the 4M element unit), or a drill-up view from the second unit to the larger first unit.

(A) With respect to all or some of items, the resource usage amount of at least one task among the plurality of tasks is represented for each of Man, Machine, and Method.
(B) With respect to each of all or some of items, the resource usage amount of at least one task among the plurality of tasks is represented.
(C) The resource usage amount of at least one task among the plurality of tasks is represented for each of Man, Machine, and Method.
(D) With respect to each of all or some of item types, the resource usage amount of at least one task among the plurality of tasks is represented.
(E) With respect to at least part of tasks among the plurality of tasks, the resource usage amount is represented.

The plurality of tasks may range over a plurality of suppliers. The usage amount information may represent the resource usage amount, with respect to each of one or more first supplier categories to which a designated supplier belongs, and each of one or more second supplier categories of one or more suppliers other than the supplier. For first and second suppliers, any of the following (X) and (Y), or the following (X) and (Y) may be switched by the processor in response to a request issued by the supplier. Accordingly, the resource usage amount can be managed in view of Scope or the like. Note that the plurality of elements may be 4M elements that are Man, Machine, Method, and Material, and with respect to at least one of (X) and (Y), about each of one or more supplier categories, the resource usage amount represented by the usage amount information may be the resource usage amount as a result of aggregation in a predetermined unit or in an unit designated by the user.

(X) The one or more first supplier categories may be Scope 1 and/or Scope 2, and the one or more second supplier categories may be Scope 3.
(Y) The one or more first supplier categories may be an own company, and the one or more second supplier categories may include an upstream one and a downstream one.

For example, as an example of the resource usage amount (or an example of the amount obtained based on the resource usage amount), the CO₂ emission can be adopted. With respect to items produced or provided through a plurality of suppliers, it is difficult to identify the CO₂ emission, and it is difficult to obtain a product passport (a collective term of data items related to detailed environment-related information about each component associated with an individual item (e.g., information related to an environment load, such as the CO₂ emission)). Accordingly, the process management data 15 has information related to the supply chain that includes a plurality of tasks of a plurality of suppliers. Thus, the CO₂ emission with respect to each supplier category, such as Scope, can be visualized. Accordingly, the supplier as the user can perform appropriate analysis. Note that in a case where the process management data 15 has such information representing the supply chain, the supplier category is not necessarily managed.

In response to the position of the user on the supply chain, the configuration of the process management model (e.g., the supplier process model corresponding to the user) can be discussed by the user (for example, discussion of the change in configuration described with reference to FIGS. 8A and 8B). For example, the processor 53 accepts a request for changing the configuration of a model part from the user, and in response to the request, the processor 53 may change the configuration of the process management model so as to match the configuration after change of the model part (for example, may copy the process management data 15, and change the configuration of the copy). The processor 53 may calculate the CO₂ emission in a case where the model part is changed, based on the process management model after configuration change, and provide the user with the CO₂ emission before and after change of the configuration of the model part.

In a case where the supplier is a finished product maker, the processor 53 may provide information representing the resource usage amount in unit of each product provided by the finished product maker, based on the environment information related to each supplier (e.g., component makers) upstream of the finished product maker, thus demonstrating to the finished product maker how each item provided by the finished product maker is successfully contributing to the environment.

The process management data 15 may represent the model that includes a plurality of nodes and a plurality of edges. For each of the plurality of tasks, the model may include a node that includes the task information corresponding to the task, a node that includes the element information associated with the task information, and a node that includes the environment information associated with the element information. Accordingly, it is expected to facilitate management for aggregating the resource usage amount.

For at least one task, information related to an item of a first item type may be associated with the task information in the process management data 15. The processor 53 may refer to the process management data 15, calculate the resource usage amount in a case of changing the item of the first item type to the item of the second item type, based on the resource usage amount corresponding to the element mode for the second item type in the environment information with which the information related to the item of the first item type is associated, and provide the information that represents the resource usage amount about the first item type, and the resource usage amount calculated about the second item type, as the usage amount information. Accordingly, for example, a simulation of how the resource usage amount changes in a case where the item of the first item type is produced or provided but the item type of the item is changed to the second item type can be achieved.

With respect to each task, the resource usage amount represented by the information that the environment information has may be a value (e.g., a predicted value) calculated based on a previously actually measured value of the resource usage amount. Accordingly, for example, even in a stage of designing the factory or designing an item, the resource usage amount of the item can be preliminarily calculated based on the process management data 15 that has information representing the resource usage amount as a predicted value.

In the process management model shown in FIG. 3, the Man node 150MW (O-Info.) may include at least part of information representing the operating time period, information representing a skill set (e.g., service years, and qualifications) of the operator. The Machine node 150MM (O-Info.) may include at least part of the information representing the operating time period (e.g., a period between times), information representing the facility setting value (e.g., the mode), information representing the facility operation (e.g., a measurement by a sensor in the facility), and information representing the resource usage amount in the facility (a value provided by a vendor). The Method node 150MS (O-Info.) may include at least part of the information representing the operating time period (e.g., a period between times), the information representing the facility setting value (e.g., the mode), and the air-conditioning setting value (in the factory). The nodes may be associated with each other without the relationship node 150R. The skill set of the operator (e.g., the operator classification (for example, whether they are an expert or a novice) identified based on the skill set of the operator) may affect the resource usage amount represented by the environment node 150E associated with the Man node 150MW, or the resource usage amount for the operator identified using the resource usage amount. At least one of the operating time period of the facility, the facility setting value, and the facility operation may affect the resource usage amount represented by the environment node 150E associated with the Machine node 150MM, or the resource usage amount for the facility identified using the resource usage amount. At least one of the operating time period of the operation, the facility setting value, and the air-conditioning setting value may affect the resource usage amount represented by the environment node 150E associated with the Method node 150MS, or the resource usage amount for the operation identified using the resource usage amount.

In the process management model shown in FIG. 3, a process may be created with respect to each item or each item type. Based on the process management model shown in FIG. 3, the resource usage amount may be aggregated. That is, the processing unit 12 may identify the environment node 150E by tracing the nodes and links from the task node 150A as the start point, with the key of the ID, and aggregate the resource usage amount, based on the resource usage amount represented by the identified environment node 150E. The ID adopted as the key may be a serial ID assigned to an individual entity, or an ID assigned in units of lots each collectively including individual entities. The task node 150A, and each 4M node 150MID are included, and tracing can be made using their IDs as the keys.

The aggregation is performed in units of products, and based on the result, the resource usage amount may be displayed in a freely selected unit, such as units of products, units of item types, units of the 4M elements, and units of the 4M entities. Alternatively, aggregation may be made in units different from the units of products, and based on the aggregate result, the resource usage amount may be displayed. For example, for each of different suppliers, with respect to the 4M element, the resource usage amount may be displayed. The Material node 150MP may correspond to a component serving as a material in the task. With respect to Material, the resource usage amount may be aggregated, from the task node 150A immediately before the product is finished, with the 4M node 150M being traced.

The correspondence relationship between the Scope classification (or categories, such as the own company, upstream, and downstream), and the supplier, is relatively changed depending on which business operator with their viewpoint is adopted. For example, in view of the component maker, the CO₂ emission pertaining to production of a certain component in the component maker (in a case where equipment used for production is operated by electricity, and the electricity is purchased from the electric power corporation), it belongs to Scope 2 (i.e., the indirect CO₂ emission due to use of electricity). In view of the finished product maker having purchased the component, the CO₂ emission belongs to Scope 3 (i.e., the product purchased by the finished product maker). This is because the component is a purchased product in view of the finished product maker. As for the CO₂ emission pertaining to production of a component by the component maker, the classification of Scope is changed depending on which viewpoint of upstream or downstream. According to the embodiments described above, on a single platform where the suppliers (e.g., a plurality of customers) collectively share information related to the environment, a subjective entity intended to be analyzed (the position on the supply chain of the subjective entity) can be displayed with the correspondence relationship between Scope and the CO₂ emission being changed. For example, if the subjective entity of data analysis is a component maker, the CO emission can be aggregated as Scope 2. If the subjective entity is a finished product maker, the CO emission can be aggregated as the Scope 3.

1. A resource usage amount management system, comprising:
a storage that stores process management data representing a flow of a plurality of tasks related to production or provision of an item; and
a processor coupled to the storage,
wherein for each of the tasks, the process management data includes:
task information that includes information related to the task with respect to each item related to the task;
element information that includes information related to each of a plurality of elements associated with the task, and is associated with the task information on the task; and
environment information that includes information related to a resource usage amount of each of the plurality of elements, and is associated with the element information on the element, and
the processor is configured to
calculate the resource usage amount in an item-by-item basis, according to information represented by the process management data, and association of information, and
provide usage amount information that is information based on the aggregated resource usage amount.

2. The resource usage amount management system according to claim 1,
wherein the plurality of elements are 4M elements that are Man, Machine, Method, and Material.

3. The resource usage amount management system according to claim 2,
wherein for a task related to items of a plurality of different item types among the plurality of tasks,
a plurality of different element modes depending on the item type is provided, with respect to at least one of the 4M elements that is associated with the task among Man, Machine, and Method,
the environment information associated with the element information on the 4M element includes information representing the resource usage amount corresponding to the element mode, with respect to each of the plurality of element modes, and
the processor is configured to calculate the resource usage amount with respect to each item type, based on the process management data.

4. The resource usage amount management system according to claim 3,
wherein for the task related to items of a plurality of different item types,
the task information includes information representing an operating time slot with respect to each item,
for each of the plurality of element modes, the element information includes information representing the time slot corresponding to the element mode,
for each of the plurality of element modes, the environment information includes information representing the resource usage amount per unit time period,
the processor is configured to
identify a task time slot that is a time slot for the task about the item, from the task information,
identify the element mode corresponding to a time slot including the identified task time slot, from the element information associated with the task information,
identify the resource usage amount per unit time period corresponding to the identified element mode, from the environment information associated with the element information, and
calculate a product of the identified resource usage amount per unit time period and the identified task time slot, as the resource usage amount for the item about the task.

5. The resource usage amount management system according to claim 3,
wherein for the task related to items of a plurality of different item types,
if the element associated with the task is Machine, the plurality of element modes are a plurality of operation modes,
if the element associated with the task is Method, the plurality of element modes are a plurality of procedure types, and
if the element associated with the task is Man, the plurality of element modes are a plurality of skill levels.

6. The resource usage amount management system according to claim 1,
wherein for each of the plurality of tasks,
the element information on the element associated with the task includes information representing a time slot corresponding to each item,
the environment information includes information representing the resource usage amount per unit time period, and
the processor is configured to
identify the time slot corresponding to the item, from the element information associated with the task,
identify the resource usage amount per unit time period, from the environment information associated with the element information, and
calculate a product of the identified resource usage amount per unit time period and the identified time slot, as the resource usage amount for the item about the task.

7. The resource usage amount management system according to claim 1,
wherein the resource usage amount represented by the usage amount information is the resource usage amount as a result of aggregation in a predetermined unit or in a unit designated by a user.

8. The resource usage amount management system according to claim 1,
wherein the plurality of tasks range over a plurality of suppliers,
the usage amount information represents the resource usage amount, with respect to each of one or more first supplier categories to which a designated supplier belongs, and each of one or more second supplier categories of one or more suppliers other than the supplier,
for first and second suppliers, any of following (X) and (Y), or following (X) and (Y) are switched by the processor in response to a request issued by the supplier,
(X) the one or more first supplier categories are Scope 1 and/or Scope 2, and the one or more second supplier categories are Scope 3,
(Y) the one or more first supplier categories are an own company, and the one or more second supplier categories include an upstream one and a downstream one.

9. The resource usage amount management system according to claim 8,
wherein the plurality of elements are 4M elements that are Man, Machine, Method, and Material, and
for at least one of (X) and (Y), with respect to each of the one or more supplier categories, the resource usage amount represented by the usage amount information is a resource usage amount as a result of aggregation in a predetermined unit or in a unit designated by a user.

10. The resource usage amount management system according to claim 1,
wherein the process management data represents a model that includes a plurality of nodes and a plurality of edges, and
for each of the plurality of tasks, the model includes a node that includes the task information corresponding to the task, a node that includes the element information associated with the task information, and a node that includes the environment information associated with the element information.

11. The resource usage amount management system according to claim 3,
wherein for at least one task, information related to an item of a first item type is associated with the task information in the process management data, and
the processor is configured to
refer to the process management data, and calculates the resource usage amount in a case where the item of the first item type is changed to an item of a second item type, based on the resource usage amount corresponding to the element mode of the second item type in the environment information with which the information related to the item of the first item type is associated, and
provide information representing the resource usage amount about the first item type, and the resource usage amount calculated about the second item type, as the usage amount information.

12. A resource usage amount management method comprising:
calculating, by a computer, a resource usage amount in an item-by-item basis, according to information represented by process management data representing a flow of a plurality of tasks related to production or provision of an item, and association of information,
wherein for each of the tasks, the process management data includes:
task information that includes information related to the task with respect to each item related to the task;
element information that includes information related to each of a plurality of elements associated with the task, and is associated with the task information on the task; and
environment information that includes information related to a resource usage amount of each of the plurality of elements, and is associated with the element information on the element, and
providing, by a computer, usage amount information that is information based on the aggregated resource usage amount.

13. A recording medium recording a computer program causing a computer to execute
calculating a resource usage amount in an item-by-item basis, according to information represented by process management data representing a flow of a plurality of tasks related to production or provision of an item, and association of information,
wherein for each of the tasks, the process management data includes:
task information that includes information related to the task with respect to each item related to the task;
element information that includes information related to each of a plurality of elements associated with the task, and is associated with the task information on the task; and
environment information that includes information related to a resource usage amount of each of the plurality of elements, and is associated with the element information on the element, and
providing usage amount information that is information based on the aggregated resource usage amount.
